(19) United States
(12) Patent Application Publication
(10) Pub. No.: US 2020/0107357 A1
(43) Pub. Date: Apr. 2, 2020

(54) GRANTLESS UPLINK (GUL) CONFIGURATION

(71) Applicant: Intel IP Corporation, Santa Clara, CA (US)

(72) Inventors: Wenting CHANG, Beijing (CN); Huaning NIU, San Jose, CA (US); Qiaoyang YE, Fremont, CA (US); Salvatore TALARICO, Sunnyvale, CA (US); Jinyu ZHANG, Beijing (CN)

(21) Appl. No.: 16/465,996

(22) PCT Filed: May 18, 2018
(86) PCT No.: PCT/US2018/033538

§ 371 Date: Nov. 5, 2019

(30) Foreign Application Priority Data
May 18, 2017 (CN) PCT/CN2017/084940

(51) Int. Cl. H04W 74/00; H04W 72/04; H04L 5/00

(52) U.S. Cl. CPC H04W 74/004; H04W 72/0413; H04W 72/0446; H04L 5/0053; H04W 72/048

(57) ABSTRACT

Embodiments of the present disclosure describe methods and apparatuses for wireless communications using grantless uplink (GUL) transmissions.

### RELATED APPLICATION

This application claims priority to PCT International Application No. PCT/CN2017/084940 filed May 18, 2017. The specification of said application is hereby incorporated by reference in its entirety.

### FIELD

Embodiments of the present disclosure generally relate to the field of wireless communications, and in particular, to grantless uplink (GUL) transmissions.

### BACKGROUND

Recently, there has been an increasing interest in operating cellular networks in the unlicensed spectrum to cope with the scarcity of low frequency bands in the licensed spectrum, with the aim to further improve data rates.

In this context, one enhancement for long term evolution (LTE) has been to enable its operation in the unlicensed spectrum via Licensed-Assisted Access (LAA), which expands the system bandwidth by utilizing the flexible carrier aggregation (CA) framework introduced by the LTE-Advanced system. Potential LTE operation in unlicensed spectrum may include, for example, (1) the LTE operation in the unlicensed spectrum via dual connectivity (DC), called DC based LAA herein, and (2) the standalone LTE system in the unlicensed spectrum, where LTE-based technology solely operates in unlicensed spectrum without requiring an “anchor” in licensed spectrum, called MulteFire. Among other things, MulteFire attempts to combine the performance benefits of LTE technology with the simplicity of Wi-Fi-like deployments to help meet the ever-increasing wireless traffic. In some cases, the unlicensed frequency band of interest in the third generation partnership project (3GPP) is the 5 GHz band, which has wide spectrum with global common availability. The 5 GHz band in the United States is governed by Unlicensed National Information Infrastructure (U-NII) rules by the Federal Communications Commission (FCC). The main incumbent system in the 5 GHz band is the Wireless Local Area Networks (WLAN), specifically those based on the IEEE802.11 a/n/ac technologies. WLAN systems are often widely deployed both by individuals and operators for carrier-grade access service and data offloading, and Listen-Before-Talk (LBT) may be considered as a feature to help provide a fair coexistence with the incumbent system. LBT is a procedure where by radio transmitters first sense the medium and transmit only if the medium is sensed to be idle.

In some cases, UL performance in unlicensed spectrum may be significantly degraded. One such cause of this degradation includes UL starvation due to the double LBT requirements at both the evolved NodeB (eNB) when sending the UL grant and at the scheduled user equipments (UEs) before transmission. This problem may result when a scheduled system (e.g., LTE) coexists with an unscheduled autonomous system (e.g., Wi-Fi).

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1A illustrates an example of co-existence between grantless uplink with scheduled uplink as well as Wi-Fi in accordance with some embodiments.

FIG. 1B illustrates an example of dynamic subframe configuration in accordance with some embodiments.

FIG. 2 illustrates an example of an operation flow/algorithmic structure in accordance with some embodiments.

FIG. 3A illustrates an example of an operation flow/algorithmic structure in accordance with some embodiments.

FIG. 3B illustrates an example of an operation flow/algorithmic structure in accordance with some embodiments.

FIG. 4 illustrates an example of an operation flow/algorithmic structure in accordance with some embodiments.

FIG. 5 depicts an architecture of a system of a network in accordance with some embodiments.

FIG. 6 depicts an example of components of a device in accordance with some embodiments.

FIG. 7 depicts an example of interfaces of baseband circuitry in accordance with some embodiments.

FIG. 8 is an illustration of a control plane protocol stack in accordance with some embodiments.

FIG. 9 is an illustration of a user plane protocol stack in accordance with some embodiments.

FIG. 10 illustrates components of a core network in accordance with some embodiments.

FIG. 11 is a block diagram illustrating components, according to some example embodiments, of a system to support network function virtualization (NFV).

FIG. 12 depicts a block diagram illustrating components, according to some example embodiments, able to read instructions from a machine-readable or computer-readable medium (e.g., a non-transitory machine-readable storage medium) and perform any one or more of the methodologies discussed herein.

### DETAILED DESCRIPTION

In the following detailed description, reference is made to the accompanying drawings, which form a part hereof wherein like numerals designate like parts throughout, and in which is shown by way of illustration embodiments that may be practiced. It is to be understood that other embodiments may be utilized and structural or logical changes may be made without departing from the scope of the present disclosure.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed or described operations may be omitted in additional embodiments.

For the purposes of the present disclosure, the phrases “A or B,” “A and/or B,” and “A/B” mean (A), (B), or (A and B).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

In order to improve the performance of uplink transmissions, embodiments of the present disclosure may utilize autonomous uplink (AUL) transmissions, also referred to herein as grantless uplink (GUL) transmissions.

In an unlicensed system according to various embodiments of the disclosure, a subframe may be dynamically configured according to the channel access condition. It can be non-valid subframe, which means the channel is not acquired by eNB. Or, if the channel is acquired by eNB, it can be either uplink or downlink subframe. Besides the subframe configuration, other parameters related to grantless uplink (GUL) may be configured by eNB through radio resource control (RRC) signaling. In order to support flexible GUL transmission, embodiments of the present disclosure may, for example, use the following approaches to configure the GUL related parameter: (1) reuse semi-persistent scheduling (SPS) configuration RRC information element (IE) with additional parameters; (2) introduce a GUL RRC IE; or (3) dynamic GUL parameter configuration. Each of these approaches are discussed in more detail below.

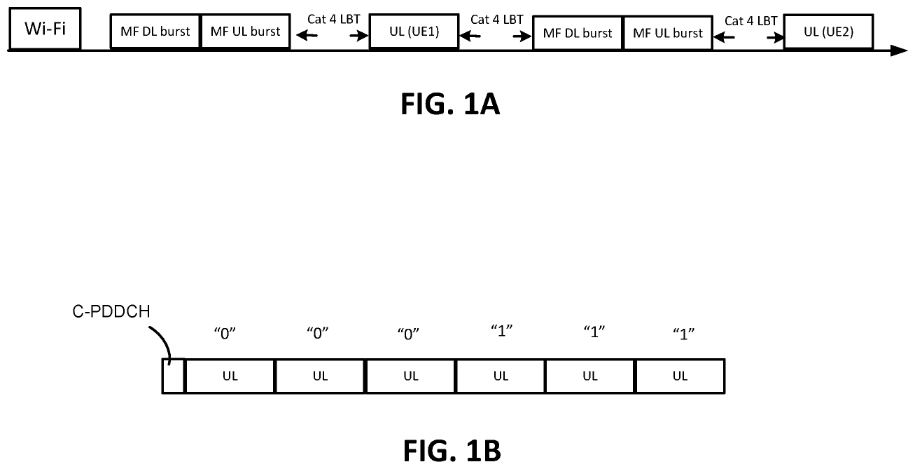

A GUL that is transmitted by a UE may coexist with scheduled uplink (SUL) downlink/uplink subframes, as well as Wi-Fi system. FIG. 1A illustrates an example of such coexistence between GUL and SUL, as well as with WFi. As illustrated in FIG. 1A, to create a harmonious environment with the transmission opportunity (TxOP) acquired by eNB, subframes allowed for GUL can be configured by eNB through high layer signaling, for example, RRC signaling.

In some embodiments, the GUL activation/release may reuse the same, or similar, procedures as SPS. Portions of an example of an IE to configure SPS are shown in Table 1 below.

TABLE 1

| | | | |
|---|---|---|---|
| SPS-Config ::= SEQUENCE { | | | |
| semiPersistSchedC-RNTI | C-RNTI | OPTIONAL, | -- Need |
| OR | | | |
| sps-ConfigDL | SPS-ConfigDL | OPTIONAL, | -- Need |
| ON | | | |
| sps-ConfigUL | SPS-ConfigUL | OPTIONAL | -- Need |
| ON | | | |
| } | | | |

SPS-ConfigUL ::= CHOICE {

| | |
|---|---|
| release | NULL, |
| setup | SEQUENCE { |

| | |
|---|---|
| semiPersistSchedIntervalUL | ENUMERATED { |

sf10, sf20, sf32, sf40, sf64, sf80,
sf128, sf160, sf320, sf640, spare6,
spare5, spare4, spare3, spare2,
spare1},

| | |
|---|---|
| implicitReleaseAfter | ENUMERATED {e2, e3, e4, e8}, |
| p0-Persistent | SEQUENCE { |

| | |
|---|---|
| p0-NominalPUSCH-Persistent | INTEGER (−126..24), |
| p0-UE-PUSCH-Persistent | INTEGER (−8..7) |

| } OPTIONAL, | | -- Need OP | |
|---|---|---|---|
| twoIntervalsConfig | ENUMERATED {true} | OPTIONAL, | -- |
| Cond TDD | | | |
| ..., | | | |

| | |
|---|---|
| [[ p0-PersistentSubframeSet2-r12 | CHOICE { |

| release | NULL, | | |
|---|---|---|---|
| setup | SEQUENCE { | | |
| p0-NominalPUSCH-PersistentSubframeSet2-r12 | | INTEGER (− | |
| 126..24), | | | |
| p0-UE-PUSCH-PersistentSubframeSet2-r12 | | INTEGER (−8..7) | |
| } | | | |
| } | | OPTIONAL | -- |
| Need ON | | | |
| ]], | | | |
| [[ numberOfConfU1SPS-Processes-r13 | INTEGER (1..8) | OPTIONAL | -- |
| Need OR | | | |
| ]] | | | |
| } | | | |

### Reuse SPS Frame Structure

In one embodiment, the RRC configuration for GUL can reuse the SPS IE with the following modifications.
Semi-persistent scheduling interval in uplink (semiPersistSchedIntervalUL) parameter. This parameter may not be needed. Instead, a 10/40 bitmap can be introduced, with “0” for non-valid GUL subframe, and “1” for valid GUL subframe. If the bitmap is not configured, all subframes can be the valid subframes for GUL by default.
Number of empty transmissions before implicit release (implicitReleaseAfter) parameter. This parameter may be not needed for GUL. The GUL is the opportunistic transmission depending on whether UE can successfully access the channel or not, so there is no guaranteed transmission.
Nominal uplink power control (p0-NominalPUSCH-Persistent) parameter. This parameter can be optional. If it is not configured, it can reuse the p0-NominalPUSCH for SUL.
Persistent scheduling uplink power control (p0-UE-PUSCH-Persistent) parameter. This parameter can be configured or not. If not, the dynamic power control can be realized by the transmit power control (TPC) field in the group downlink control information (G-DCI).
Two-intervals-SPS enabling (TwolntervalsConfig) parameter. This parameter may not be needed, since there may not be a fixed downlink and uplink configuration as with a time division duplex (TDD) system.
Uplink power control subframe set 2 (p0-PersistentSubframeSet2-r12) parameter. This parameter may not be needed, since one power control mechanism may be enough for GUL.
A number of configured uplink SPS processes (numberOfConfULSPS-Processes-r13) parameter. This parameter may not be needed, since the hybrid automatic repeat request (HARQ) for GUL configuration can be configured by activation/release DCI.
Semi-persistent scheduling cell radio network temporary identifier (semiPersistSchedC-RNTI) parameter. This parameter can be reused as the grantless-RNTI.

In one embodiment, besides the existing bit field, additional parameters may be added in the SPS IE. The additional parameters may include the following, in any combination.
demodulation reference signal (DMRS) parameters, including orthogonal cover code (OCC) and cyclic shift.
A modulation and coding scheme (MCS) parameter.
A maximum transport block (TB) number parameter to configure the maximum TB number (e.g., 1 or 2).
A resource allocation parameter, if frequency division multiplexed (FDMed) GUL is enabled.
A Timer A value, which may be set between the group downlink control information (G-DCI) and the supplementary uplink (SUL) retransmission grant. If SUL retransmission grant is not received within Timer A after G-DCI, GUL retransmission may be performed.
A Timer B value. After GUL transmission, if no G-DCI is received within Timer B, GUL retransmissions may be performed.
A UE specific offset or reservation signal range. This parameter configures the maximum range for UE specific offset or reservation signal.
A redundant version (RV). This RV is for initial GUL transmission.
A flag_ACSI_DLHARQ. This parameter may indicate whether the abstract communication service interface (ACSI), downlink HARQ acknowledgment/non-acknowledgment (ACK/NCK) is transmitted in GUL or not.
A G-DCI_formattype. This parameter indicates which G-DCI format is utilized, (e.g., “0” for compacted G-DCI, and “1” for extended G-DCI.)

### Generate New RRC IE

In some embodiments, a new RRC IE can be defined for GUL, which may contain one or multiple parameters as shown below. In some embodiments, the parameters below may be either mandatory or optional. In some embodiments, one or multiple parameters may not be configured by RRC signaling, but instead configured through activation/release DCI. In some embodiments, any one of the parameters below may be configured in either a cell-specific fashion or a UE-specific fashion.

The RRC IE may include any number of parameters, including multiple parameters of the same type. A list of possible parameter types that may be used in conjunction with embodiments of the present disclosure may include: a parameter identifying a number of configured hybrid automatic repeat request (HARQ) processes for uplink semi-persistent scheduling (ULSPS); a cell radio network temporary identifier (C-RNTI) parameter; a demodulation reference signal design (DMRS) orthogonal cover code (OCC) parameter; a DMRS cyclic shift parameter; a timer parameter; a UE-specific offset parameter; a UE reservation signal range; a nominal physical uplink shared channel (PUSCH) power parameter; a UE PUSCH power parameter; a DMRS modulation and coding scheme (MCS) parameter; a transport block (TB) number parameter; a layer number parameter; a resource allocation parameter for frequency division multiplexed (FDM) GUL; a redundant version (RV) parameter; an adjacent channel selectivity (ACS) downlink hybrid automatic repeat request (DLHARQ) flag parameter; or a downlink control information (DCI) format type parameter.

Some examples of particular parameters that may be included in the RRC IE include:
semiPersistSchedIntervalUL. This parameter may not be needed. Instead, a 10/40 bitmap can be introduced, with “0” for non-valid GUL subframe, and “1” for valid GUL subframe.
p0-NominalPUSCH-Persistent.
p0-UE-PUSCH-Persistent.
numberOfConfU1SPS-Processes-r13.
semiPersistSchedC-RNTI.
DMRS parameters, including OCC and cyclic shift.
MCS.
Maximum TB number.
Resource allocation, if FDMed GUL is enabled.
Timer A.
Timer B.
The UE specific offset or reservation signal range.
redundant version (RV).
flag_ACSI_DLHARQ.
G-DCI_format_type.

### Dynamic GUL Parameter Configuration

In one embodiment, if one parameter has been configured through RRC signaling but is also configured in the activation/release DCI, the value in activation/release DCI can overwrite the value in RRC. In some embodiments, downlink transmission and SUL may be given higher priority than GUL, which may be dynamically configured by eNB.

In one embodiment, the dynamic subframe configuration can rewrite the valid GUL subframe configuration. An example is illustrated in FIG. 1B, where subframes four through six (the three right-most frames in the figure) are configured as valid subframes according to the bitmap signaled through RRC, while conventional physical downlink control channel (cPDCCH) includes DCI to indicate that these three subframes are scheduled uplink subframes. In this case, three subframes (the three left-most frames in the figure) are overwritten as invalid subframes.

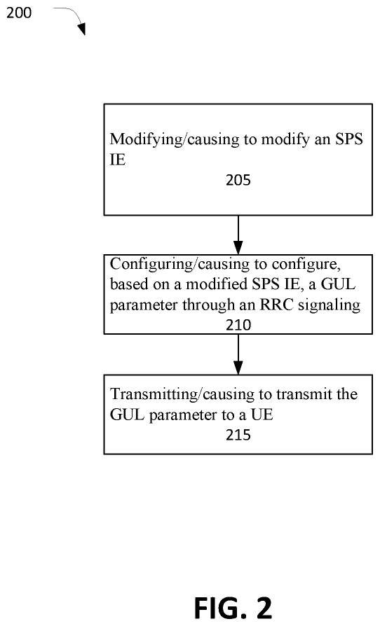

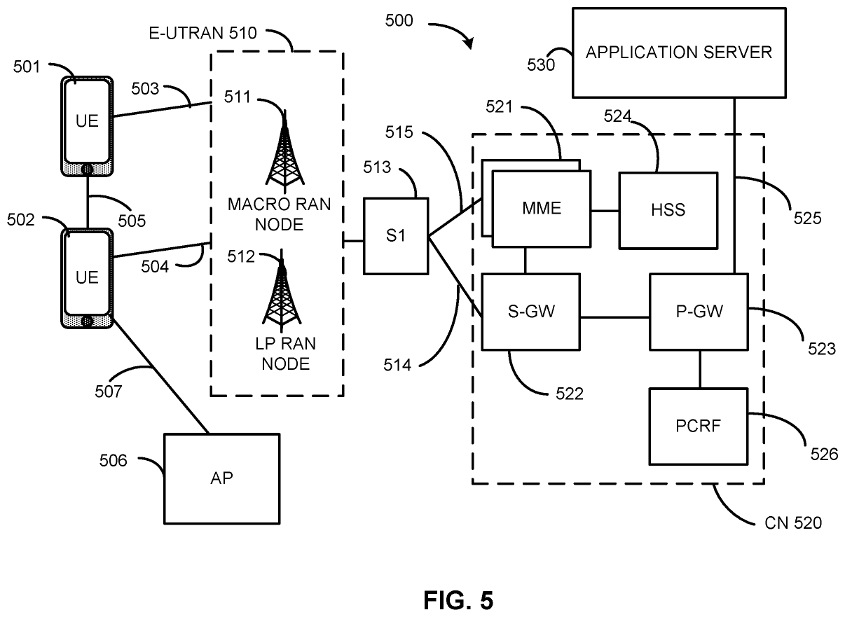

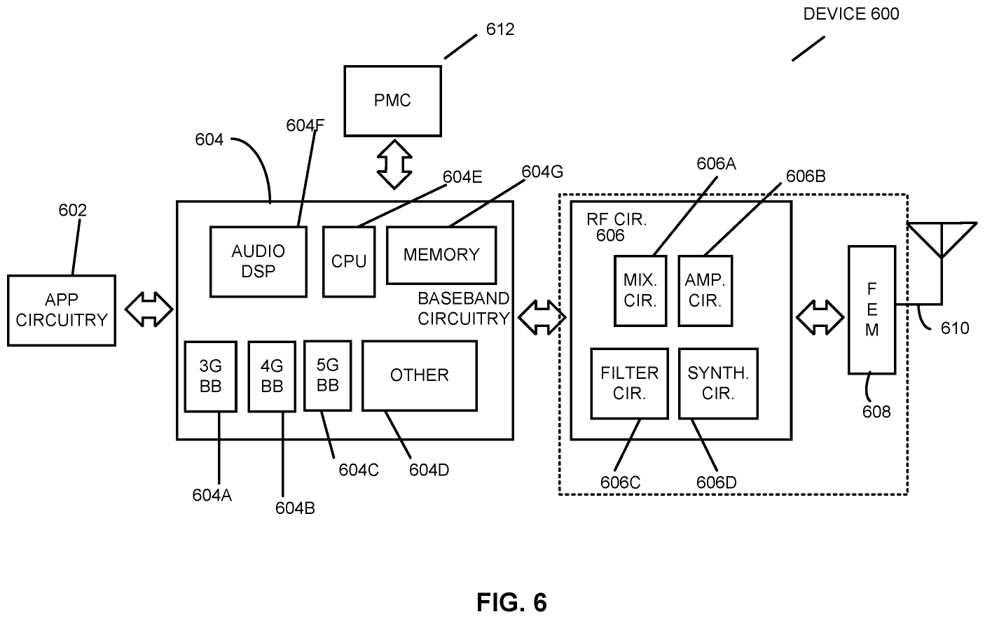

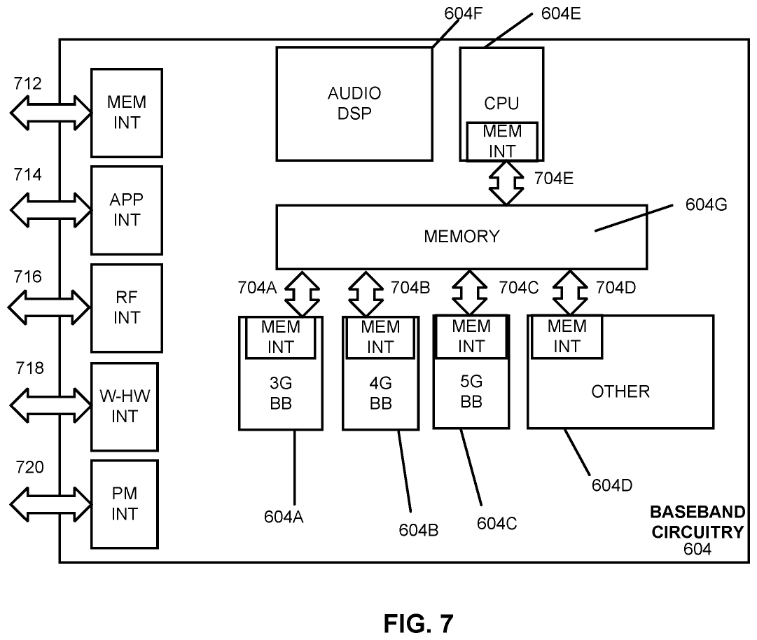

In some embodiments, the electronic device(s), network(s), system(s), chip(s) or component(s), or portions or implementations thereof, of FIGS. 5-12 herein may be configured to perform or execute one or more operation flow/algorithmic structures, processes, techniques, or methods as described herein, or portions thereof. One such operation flow/algorithmic structure is depicted in FIG. 2. In this example, operation flow/algorithmic structure 200 may include, at 205, modifying or causing to modify an SPS IE. The modification may occur by circuitry of an eNB, for example, baseband circuitry as shown in FIGS. 6 and 7, generating an SPS IE with a structure similar to that shown above with respect to Table 1. In some embodiments, the SPS IE may be modified to include parameters/values for GUL operation.

The operation flow/algorithmic structure 200 may further include, at 210, configuring or causing to configure, based on a modified SPS IE, GUL parameters/values through RRC signaling. In some embodiments, the configuration may include circuitry of the eNB, for example, baseband circuitry, generating an RRC message/signal to include the modified SPS IE.

The operation flow/algorithmic structure 200 may further include, at 215, transmitting or causing to transmit the GUL parameter to a UE. In some embodiments, baseband circuitry of the eNB may control radio frequency (RF) circuitry to transmit the RRC message/signal. Circuitry of the eNB generating and transmitting messages is described in further detail below.

In some embodiments, the RRC message/signal may be transmitted as part of an RRC configuration process. In these embodiments, the RRC message/signal may be an RRC reconfiguration message.

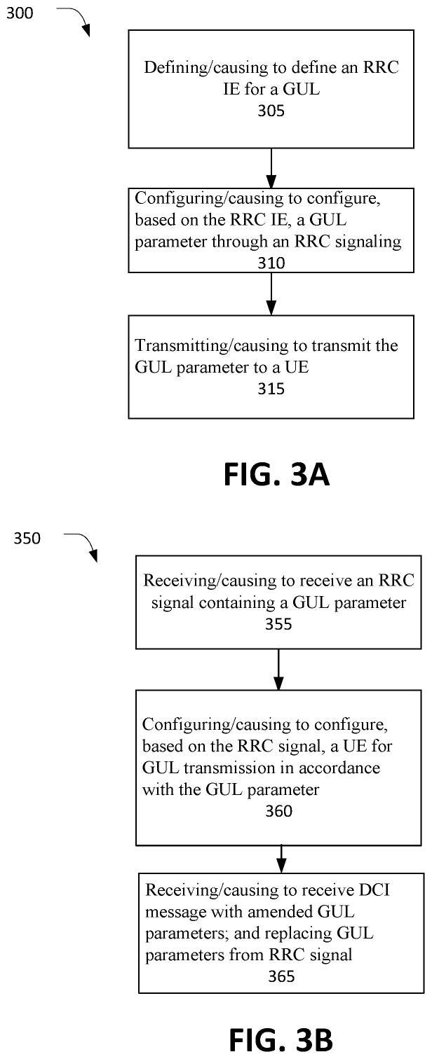

Another such operation flow/algorithmic structure 300 is depicted in FIG. 3A, which may be performed by the circuitry of an eNB. In this example, operation flow/algorithmic structure 300 may include, at 305, defining or causing to define an RRC IE for a GUL. Operation flow/algorithmic structure 300 may further include configuring or causing to configure, based on the RRC IE, a GUL parameter through an RRC signaling (310), and transmitting or causing to transmit the GUL parameter to a UE (315). Examples of GUL parameters that may be included in the RRC IE are described in more detail above. An RRC IE defined in accordance with embodiments of the present disclosure may include any suitable number, and combination, of GUL parameters.

Another operation flow/algorithmic structure 350 is depicted in FIG. 3B, which may be performed by a UE, such as UEs 501 or 502 depicted in FIG. 5, such as via the circuitry and components depicted in FIGS. 6 and 7. In the example shown in FIG. 3B, operation flow/algorithmic structure 350 may include, at 355, receiving/causing to receive an RRC signal containing a GUL parameter. The GUL parameter may be included in the RRC signal in an RRC IE as described previously. As with other embodiments disclosed herein, the RRC signal may include any suitable number, and combination, of GUL parameters. Operation flow/algorithmic structure 350 may further include, at 360, configuring/causing to configure, based on the RRC signal, a UE for GUL transmission in accordance with the GUL parameter.

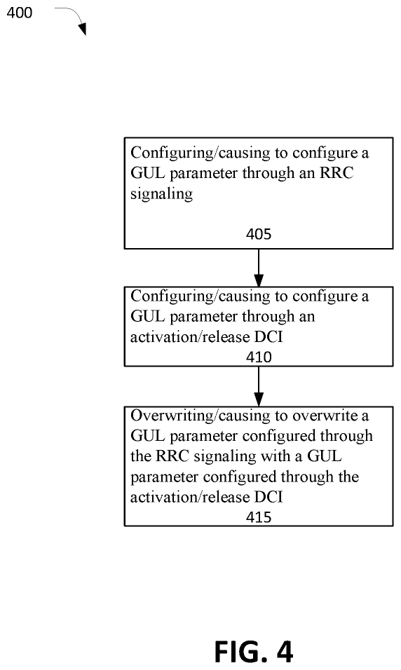

Operation flow/algorithmic structure 350 may further include, at 365, receiving/causing to receive a DCI message with amended GUL parameters; and replacing GUL parameters from the RRC signal. For example, as likewise described below for operation flow/algorithmic structure 400, a DCI message (e.g., a DCI activation or a DCI release) may contain one or more amended GUL parameters. In response to receiving the DCI message, the values in one or more GUL parameters in the RRC signal may be replaced (i.e., overwritten) by one or more amended GUL parameters in the DCI message. Another operation flow/algorithmic structure 400 is depicted in FIG. 4, which may be performed by an eNB. In this example, operation flow/algorithmic structure 400 may include, at 405, configuring or causing to configure a GUL parameter through an RRC signaling Operation flow/algorithmic structure 400 may further include, at 410, configuring or causing to configure a GUL parameter through an activation/release DCI. Operation flow/algorithmic structure 400 may also include, at 415, overwriting or causing to overwrite a GUL parameter configured through the RRC signaling with a GUL parameter configured through the activation/release DCI.

FIG. 5 illustrates an architecture of a system 500 of a network in accordance with some embodiments. The system 500 is shown to include a user equipment (UE) 501 and a UE 502. The UEs 501 and 502 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, any of the UEs 501 and 502 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 501 and 502 may be configured to connect, e.g., communicatively couple, with a radio access network (RAN) 510—the RAN 510 may be, for example, an Evolved Universal Mobile Telecommunications System (UMTS) Terrestrial Radio Access Network (E-UTRAN), a NextGen RAN (NG RAN), or some other type of RAN. The UEs 501 and 502 utilize connections 503 and 504, respectively, each of which comprises a physical communications interface or layer (discussed in further detail below); in this example, the connections 503 and 504 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 501 and 502 may further directly exchange communication data via a ProSe interface 505. The ProSe interface 505 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 502 is shown to be configured to access an access point (AP) 506 via connection 507. The connection 507 can comprise a local wireless connection, such as a connection consistent with any IEEE 802.11 protocol, wherein the AP 506 would comprise a wireless fidelity (WiFi®) router. In this example, the AP 506 is shown to be connected to the Internet without connecting to the core network of the wireless system (described in further detail below).

The RAN 510 can include one or more access nodes that enable the connections 503 and 504. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The RAN 510 may include one or more RAN nodes for providing macrocells, e.g., macro RAN node 511, and one or more RAN nodes for providing femtocells or picocells (e.g., cells having smaller coverage areas, smaller user capacity, or higher bandwidth compared to macrocells), e.g., low power (LP) RAN node 512.

Any of the RAN nodes 511 and 512 can terminate the air interface protocol and can be the first point of contact for the UEs 501 and 502. In some embodiments, any of the RAN nodes 511 and 512 can fulfill various logical functions for the RAN 510 including, but not limited to, radio network controller (RNC) functions such as radio bearer management, uplink and downlink dynamic radio resource management and data packet scheduling, and mobility management.

In accordance with some embodiments, the UEs 501 and 502 can be configured to communicate using Orthogonal Frequency-Division Multiplexing (OFDM) communication signals with each other or with any of the RAN nodes 511 and 512 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 511 and 512 to the UEs 501 and 502, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UEs 501 and 502. The physical downlink control channel (PDCCH) may carry information about the transport format and resource allocations related to the PDSCH channel, among other things. It may also inform the UEs 501 and 502 about the transport format, resource allocation, and H-ARQ (Hybrid Automatic Repeat Request) information related to the uplink shared channel Typically, downlink scheduling (assigning control and shared channel resource blocks to the UE 502 within a cell) may be performed at any of the RAN nodes 511 and 512 based on channel quality information fed back from any of the UEs 501 and 502. The downlink resource assignment information may be sent on the PDCCH used for (e.g., assigned to) each of the UEs 501 and 502. The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced control channel elements (ECCEs). Similar to above, each ECCE may correspond to nine sets of four physical resource elements known as enhanced resource element groups (EREGs). An ECCE may have other numbers of EREGs in some situations.

The RAN 510 is shown to be communicatively coupled to a core network (CN) 520—via an S1 interface 513. In embodiments, the CN 520 may be an evolved packet core (EPC) network, a NextGen Packet Core (NPC) network, or some other type of CN. In this embodiment, the S1 interface 513 is split into two parts: the S1-U interface 514, which carries traffic data between the RAN nodes 511 and 512 and the serving gateway (S-GW) 522, and the S1-mobility management entity (MME) interface 515, which is a signaling interface between the RAN nodes 511 and 512 and MMEs 521.

In this embodiment, the CN 520 comprises the MMEs 521, the S-GW 522, the Packet Data Network (PDN) Gateway (P-GW) 523, and a home subscriber server (HSS) 524. The MMEs 521 may be similar in function to the control plane of legacy Serving General Packet Radio Service (GPRS) Support Nodes (SGSN). The MMEs 521 may manage mobility aspects in access such as gateway selection and tracking area list management. The HSS 524 may comprise a database for network users, including subscription-related information to support the network entities' handling of communication sessions. The CN 520 may comprise one or several HSSs 524, depending on the number of mobile subscribers, on the capacity of the equipment, on the organization of the network, etc. For example, the HSS 524 can provide support for routing/roaming, authentication, authorization, naming/addressing resolution, location dependencies, etc.

The S-GW 522 may terminate the S1 interface 513 towards the RAN 510, and routes data packets between the RAN 510 and the CN 520. In addition, the S-GW 522 may be a local mobility anchor point for inter-RAN node handovers and also may provide an anchor for inter-3GPP mobility. Other responsibilities may include lawful intercept, charging, and some policy enforcement.

The P-GW 523 may terminate an SGi interface toward a PDN. The P-GW 523 may route data packets between the EPC network and external networks such as a network including the application server 530 (alternatively referred to as application function (AF)) via an Internet Protocol (IP) interface 525. Generally, the application server 530 may be an element offering applications that use IP bearer resources with the core network (e.g., UMTS Packet Services (PS) domain, LTE PS data services, etc.). In this embodiment, the P-GW 523 is shown to be communicatively coupled to an application server 530 via an IP communications interface 525. The application server 530 can also be configured to support one or more communication services (e.g., Voice-over-Internet Protocol (VoIP) sessions, PTT sessions, group communication sessions, social networking services, etc.) for the UEs 501 and 502 via the CN 520.

The P-GW 523 may further be a node for policy enforcement and charging data collection. Policy and Charging Enforcement Function (PCRF) 526 is the policy and charging control element of the CN 520. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 526 may be communicatively coupled to the application server 530 via the P-GW 523. The application server 530 may signal the PCRF 526 to indicate a new service flow and select the appropriate Quality of Service (QoS) and charging parameters. The PCRF 526 may provision this rule into a Policy and Charging Enforcement Function (PCEF) (not shown) with the appropriate traffic flow template (TFT) and QoS class of identifier (QCI), which commences the QoS and charging as specified by the application server 530.

FIG. 6 illustrates example components of a device 600 in accordance with some embodiments. In some embodiments, the device 600 may include application circuitry 602, baseband circuitry 604, Radio Frequency (RF) circuitry 606, front-end module (FEM) circuitry 608, one or more antennas 610, and power management circuitry (PMC) 612 coupled together at least as shown. The components of the illustrated device 600 may be included in a UE or a RAN node. In some embodiments, the device 600 may include fewer elements (e.g., a RAN node may not utilize application circuitry 602, and instead include a processor/controller to process IP data received from an EPC). In some embodiments, the device 600 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 602 may include one or more application processors. For example, the application circuitry 602 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 600. In some embodiments, processors of application circuitry 602 may process IP data packets received from an EPC.

The baseband circuitry 604 may include circuitry such as, but not limited to, one or more single-core or multi-core processors. The baseband circuitry 604 may include one or more baseband processors or control logic to process baseband signals received from a receive signal path of the RF circuitry 606 and to generate baseband signals for a transmit signal path of the RF circuitry 606. Baseband processing circuitry 604 may interface with the application circuitry 602 for generation and processing of the baseband signals and for controlling operations of the RF circuitry 606. For example, in some embodiments, the baseband circuitry 604 may include a third generation (3G) baseband processor 604A, a fourth generation (4G) baseband processor 604B, a fifth generation (5G) baseband processor 604C, or other baseband processor(s) 604D for other existing generations, generations in development or to be developed in the future (e.g., second generation (2G), sixth generation (6G), etc.). The baseband circuitry 604 (e.g., one or more of baseband processors 604A-D) may handle various radio control functions that enable communication with one or more radio networks via the RF circuitry 606. In other embodiments, some or all of the functionality of baseband processors 604A-D may be included in modules stored in the memory 604G and executed via a Central Processing Unit (CPU) 604E. The radio control functions may include, but are not limited to, signal modulation/demodulation, encoding/decoding, radio frequency shifting, etc. In some embodiments, modulation/demodulation circuitry of the baseband circuitry 604 may include Fast-Fourier Transform (FFT), precoding, or constellation mapping/demapping functionality. In some embodiments, encoding/decoding circuitry of the baseband circuitry 604 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 604 may include one or more audio digital signal processor(s) (DSP) 604F. The audio DSP(s) 604F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 604 and the application circuitry 602 may be implemented together such as, for example, on a system on a chip (SOC).

In some embodiments, the baseband circuitry 604 may provide for communication compatible with one or more radio technologies. For example, in some embodiments, the baseband circuitry 604 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 604 is configured to support radio communications of more than one wireless protocol may be referred to as multi-mode baseband circuitry.

RF circuitry 606 may enable communication with wireless networks using modulated electromagnetic radiation through a non-solid medium. In various embodiments, the RF circuitry 606 may include switches, filters, amplifiers, etc. to facilitate the communication with the wireless network. RF circuitry 606 may include a receive signal path which may include circuitry to down-convert RF signals received from the FEM circuitry 608 and provide baseband signals to the baseband circuitry 604. RF circuitry 606 may also include a transmit signal path which may include circuitry to up-convert baseband signals provided by the baseband circuitry 604 and provide RF output signals to the FEM circuitry 608 for transmission.

In some embodiments, the receive signal path of the RF circuitry 606 may include mixer circuitry 606a, amplifier circuitry 606b and filter circuitry 606c. In some embodiments, the transmit signal path of the RF circuitry 606 may include filter circuitry 606c and mixer circuitry 606a. RF circuitry 606 may also include synthesizer circuitry 606d for synthesizing a frequency for use by the mixer circuitry 606a of the receive signal path and the transmit signal path. In some embodiments, the mixer circuitry 606a of the receive signal path may be configured to down-convert RF signals received from the FEM circuitry 608 based on the synthesized frequency provided by synthesizer circuitry 606d. The amplifier circuitry 606b may be configured to amplify the down-converted signals and the filter circuitry 606c may be a low-pass filter (LPF) or band-pass filter (BPF) configured to remove unwanted signals from the down-converted signals to generate output baseband signals. Output baseband signals may be provided to the baseband circuitry 604 for further processing. In some embodiments, the output baseband signals may be zero-frequency baseband signals, although this is not a requirement. In some embodiments, mixer circuitry 606a of the receive signal path may comprise passive mixers, although the scope of the embodiments is not limited in this respect.

In some embodiments, the mixer circuitry 606a of the transmit signal path may be configured to up-convert input baseband signals based on the synthesized frequency provided by the synthesizer circuitry 606d to generate RF output signals for the FEM circuitry 608. The baseband signals may be provided by the baseband circuitry 604 and may be filtered by filter circuitry 606c.

In some embodiments, the mixer circuitry 606a of the receive signal path and the mixer circuitry 606a of the transmit signal path may include two or more mixers and may be arranged for quadrature downconversion and upconversion, respectively. In some embodiments, the mixer circuitry 606a of the receive signal path and the mixer circuitry 606a of the transmit signal path may include two or more mixers and may be arranged for image rejection (e.g., Hartley image rejection). In some embodiments, the mixer circuitry 606a of the receive signal path and the mixer circuitry 606a of the transmit signal path may be arranged for direct downconversion and direct upconversion, respectively. In some embodiments, the mixer circuitry 606a of the receive signal path and the mixer circuitry 606a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 606 may include analog-to-digital converter (ADC) and digital-to-analog converter (DAC) circuitry and the baseband circuitry 604 may include a digital baseband interface to communicate with the RF circuitry 606.

In some dual-mode embodiments, a separate radio IC circuitry may be provided for processing signals for each spectrum, although the scope of the embodiments is not limited in this respect.

In some embodiments, the synthesizer circuitry 606d may be a fractional-N synthesizer or a fractional N/N+1 synthesizer, although the scope of the embodiments is not limited in this respect as other types of frequency synthesizers may be suitable. For example, synthesizer circuitry 606d may be a delta-sigma synthesizer, a frequency multiplier, or a synthesizer comprising a phase-locked loop with a frequency divider.

The synthesizer circuitry 606d may be configured to synthesize an output frequency for use by the mixer circuitry 606a of the RF circuitry 606 based on a frequency input and a divider control input. In some embodiments, the synthesizer circuitry 606d may be a fractional N/N+1 synthesizer.

In some embodiments, frequency input may be provided by a voltage controlled oscillator (VCO), although that is not a requirement. Divider control input may be provided by either the baseband circuitry 604 or the applications processor 602 depending on the desired output frequency. In some embodiments, a divider control input (e.g., N) may be determined from a look-up table based on a channel indicated by the applications processor 602.

Synthesizer circuitry 606d of the RF circuitry 606 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 606d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 606 may include an IQ/polar converter. FEM circuitry 608 may include a receive signal path, which may include circuitry configured to operate on RF signals received from one or more antennas 610, amplify the received signals and provide the amplified versions of the received signals to the RF circuitry 606 for further processing. FEM circuitry 608 may also include a transmit signal path, which may include circuitry configured to amplify signals for transmission provided by the RF circuitry 606 for transmission by one or more of the one or more antennas 610. In various embodiments, the amplification through the transmit or receive signal paths may be done solely in the RF circuitry 606, solely in the FEM 608, or in both the RF circuitry 606 and the FEM 608.

In some embodiments, the FEM circuitry 608 may include a TX/RX switch to switch between transmit mode and receive mode operation. The FEM circuitry 608 may include a receive signal path and a transmit signal path. The receive signal path of the FEM circuitry 608 may include a low noise amplifier (LNA) to amplify received RF signals and provide the amplified received RF signals as an output (e.g., to the RF circuitry 606). The transmit signal path of the FEM circuitry 608 may include a power amplifier (PA) to amplify input RF signals (e.g., provided by RF circuitry 606), and one or more filters to generate RF signals for subsequent transmission (e.g., by one or more of the one or more antennas 610).

In some embodiments, the PMC 612 may manage power provided to the baseband circuitry 604. In particular, the PMC 612 may control power-source selection, voltage scaling, battery charging, or DC-to-DC conversion. The PMC 612 may often be included when the device 600 is capable of being powered by a battery, for example, when the device is included in a UE. The PMC 612 may increase the power conversion efficiency while providing desirable implementation size and heat dissipation characteristics.

FIG. 6 shows the PMC 612 coupled only with the baseband circuitry 604. However, in other embodiments, the PMC 612 may be additionally or alternatively coupled with, and perform similar power management operations for, other components such as, but not limited to, application circuitry 602, RF circuitry 606, or FEM 608.

In some embodiments, the PMC 612 may control, or otherwise be part of, various power saving mechanisms of the device 600. For example, if the device 600 is in an RRC_Connected state, where it is still connected to the RAN node as it expects to receive traffic shortly, then it may enter a state known as Discontinuous Reception Mode (DRX) after a period of inactivity. During this state, the device 600 may power down for brief intervals of time and thus save power.

If there is no data traffic activity for an extended period of time, then the device 600 may transition off to an RRC Idle state, where it disconnects from the network and does not perform operations such as channel quality feedback, handover, etc. The device 600 goes into a very low power state and it performs paging where again it periodically wakes up to listen to the network and then powers down again. The device 600 may not receive data in this state, in order to receive data, it must transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 602 and processors of the baseband circuitry 604 may be used to execute elements of one or more instances of a protocol stack. For example, processors of the baseband circuitry 604, alone or in combination, may be used to execute Layer 3, Layer 2, or Layer 1 functionality, while processors of the application circuitry 602 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

FIG. 7 illustrates example interfaces of baseband circuitry in accordance with some embodiments. As discussed above, the baseband circuitry 604 of FIG. 6 may comprise processors 604A-604E and a memory 604G utilized by said processors. Each of the processors 604A-604E may include a memory interface, 704A-704E, respectively, to send/receive data to/from the memory 604G.

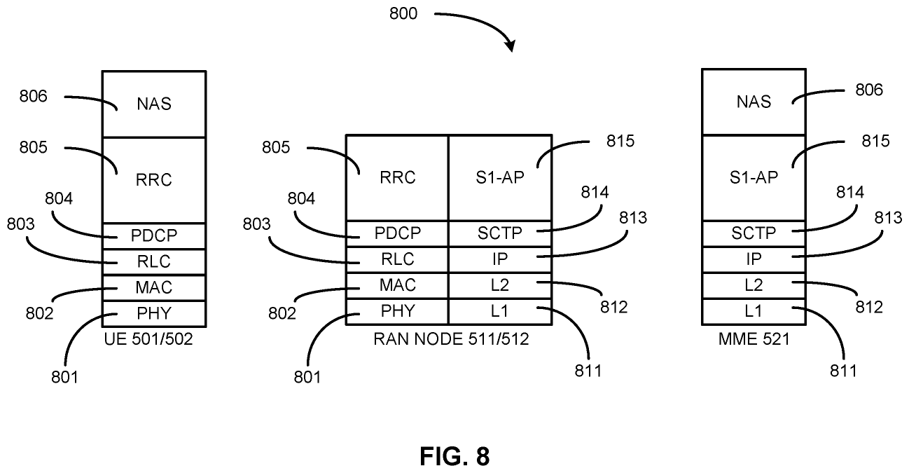

The baseband circuitry 604 may further include one or more interfaces to communicatively couple to other circuitries/devices, such as a memory interface 712 (e.g., an interface to send/receive data to/from memory external to the baseband circuitry 604), an application circuitry interface 714 (e.g., an interface to send/receive data to/from the application circuitry 602 of FIG. 6), an RF circuitry interface 716 (e.g., an interface to send/receive data to/from RF circuitry 606 of FIG. 6), a wireless hardware connectivity interface 718 (e.g., an interface to send/receive data to/from Near Field Communication (NFC) components, Bluetooth® components (e.g., Bluetooth® Low Energy), Wi-Fi® components, and other communication components), and a power management interface 720 (e.g., an interface to send/receive power or control signals to/from the PMC 612. FIG. 8 is an illustration of a control plane protocol stack in accordance with some embodiments. In this embodiment, a control plane 800 is shown as a communications protocol stack between the UE 501 (or alternatively, the UE 502), the RAN node 511 (or alternatively, the RAN node 512), and the MME 521.

The PHY layer 801 may transmit or receive information used by the MAC layer 802 over one or more air interfaces. The PHY layer 801 may further perform link adaptation or adaptive modulation and coding (AMC), power control, cell search (e.g., for initial synchronization and handover purposes), and other measurements used by higher layers, such as the RRC layer 805. The PHY layer 801 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 802 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer 803 may operate in a plurality of modes of operation, including: Transparent Mode (TM), Unacknowledged Mode (UM), and Acknowledged Mode (AM). The RLC layer 803 may execute transfer of upper layer protocol data units (PDUs), error correction through automatic repeat request (ARQ) for AM data transfers, and concatenation, segmentation and reassembly of RLC SDUs for UM and AM data transfers. The RLC layer 803 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment. The PDCP layer 804 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 805 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection between the UE and E-UTRAN (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. Said MIBs and SIBs may comprise one or more information elements (IEs), which may each comprise individual data fields or data structures.

The UE 501 and the RAN node 511 may utilize a Uu interface (e.g., an LTE-Uu interface) to exchange control plane data via a protocol stack comprising the PHY layer 801, the MAC layer 802, the RLC layer 803, the PDCP layer 804, and the RRC layer 805. The non-access stratum (NAS) protocols 806 form the highest stratum of the control plane between the UE 501 and the MME 521. The NAS protocols 806 support the mobility of the UE 501 and the session management procedures to establish and maintain IP connectivity between the UE 501 and the P-GW 523.

The S1 Application Protocol (S1-AP) layer 815 may support the functions of the S1 interface and comprise Elementary Procedures (EPs). An EP is a unit of interaction between the RAN node 511 and the CN 520. The S1-AP layer services may comprise two groups: UE-associated services and non-UE-associated services. These services perform functions including, but not limited to: E-UTRAN Radio Access Bearer (E-RAB) management, UE capability indication, mobility, NAS signaling transport, RAN Information Management (RIM), and configuration transfer.

The Stream Control Transmission Protocol (SCTP) layer (alternatively referred to as the SCTP/IP layer) 814 may ensure reliable delivery of signaling messages between the RAN node 511 and the MME 521 based, in part, on the IP protocol, supported by the IP layer 813. The L2 layer 812 and the L1 layer 811 may refer to communication links (e.g., wired or wireless) used by the RAN node and the MME to exchange information.

The RAN node 511 and the MME 521 may utilize an S1-MME interface to exchange control plane data via a protocol stack comprising the L1 layer 811, the L2 layer 812, the IP layer 813, the SCTP layer 814, and the S1-AP layer 815.

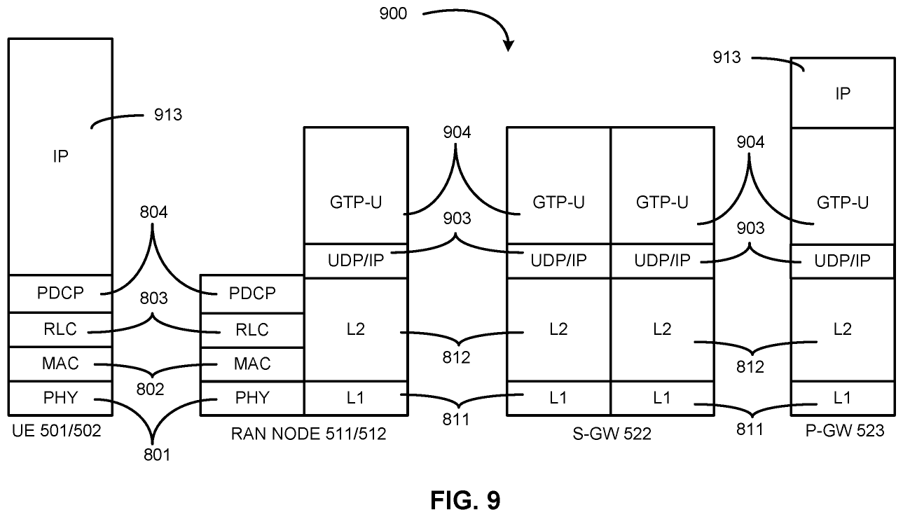

FIG. 9 is an illustration of a user plane protocol stack in accordance with some embodiments. In this embodiment, a user plane 900 is shown as a communications protocol stack between the UE 501 (or alternatively, the UE 502), the RAN node 511 (or alternatively, the RAN node 512), the S-GW 522, and the P-GW 523. The user plane 900 may utilize at least some of the same protocol layers as the control plane 800. For example, the UE 501 and the RAN node 511 may utilize a Uu interface (e.g., an LTE-Uu interface) to exchange user plane data via a protocol stack comprising the PHY layer 801, the MAC layer 802, the RLC layer 803, the PDCP layer 804.

The General Packet Radio Service (GPRS) Tunneling Protocol for the user plane (GTP-U) layer 904 may be used for carrying user data within the GPRS core network and between the radio access network and the core network. The user data transported can be packets in any of IPv4, IPv6, or PPP formats, for example. The UDP and IP security (UDP/IP) layer 913 may provide checksums for data integrity, port numbers for addressing different functions at the source and destination, and encryption and authentication on the selected data flows. The RAN node 511 and the S-GW 522 may utilize an S1-U interface to exchange user plane data via a protocol stack comprising the L1 layer 811, the L2 layer 812, the UDP/IP layer 913, and the GTP-U layer 904. The S-GW 522 and the P-GW 523 may utilize an S5/S8a interface to exchange user plane data via a protocol stack comprising the L1 layer 811, the L2 layer 812, the UDP/IP layer 913, and the GTP-U layer 904. As discussed above with respect to FIG. 8, NAS protocols support the mobility of the UE 501 and the session management procedures to establish and maintain IP connectivity between the UE 501 and the P-GW 523.

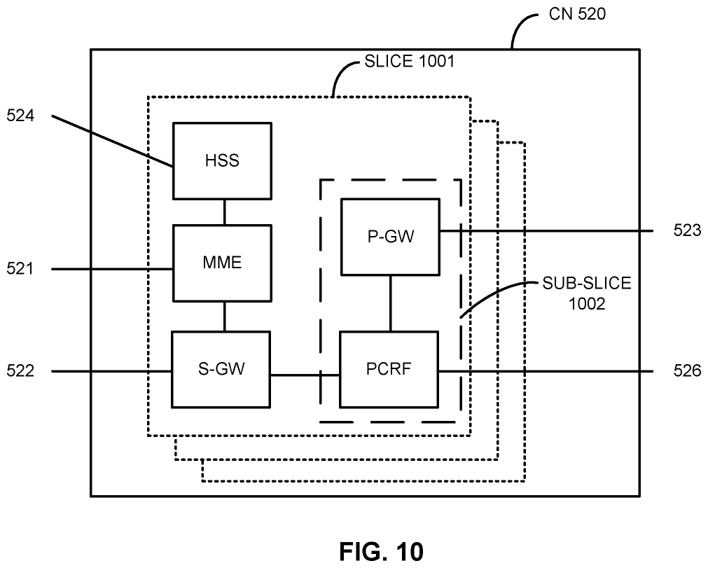

FIG. 10 illustrates components of a core network in accordance with some embodiments. The components of the CN 520 may be implemented in one physical node or separate physical nodes including components to read and execute instructions from a machine-readable or computer-readable medium (e.g., a non-transitory machine-readable storage medium). In some embodiments, Network Functions Virtualization (NFV) is utilized to virtualize any or all of the above described network node functions via executable instructions stored in one or more computer readable storage mediums (described in further detail below). A logical instantiation of the CN 520 may be referred to as a network slice 1001. A logical instantiation of a portion of the CN 520 may be referred to as a network sub-slice 1002 (e.g., the network sub-slice 1002 is shown to include the PGW 523 and the PCRF 526).

NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

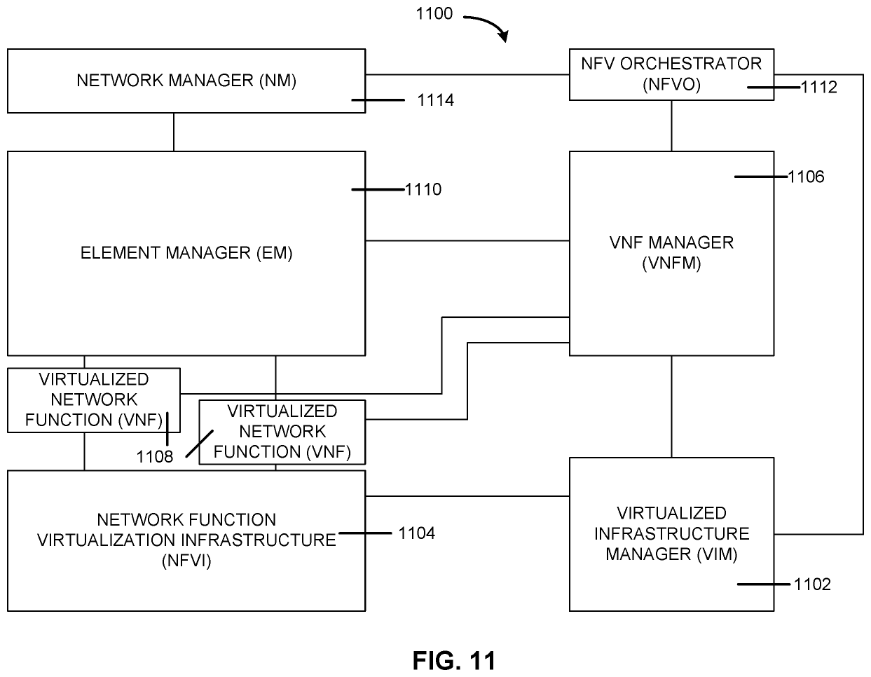

FIG. 11 is a block diagram illustrating components, according to some example embodiments, of a system 1100 to support NFV. The system 1100 is illustrated as including a virtualized infrastructure manager (VIM) 1102, a network function virtualization infrastructure (NFVI) 1104, a VNF manager (VNFM) 1106, virtualized network functions (VNFs) 1108, an element manager (EM) 1110, an NFV Orchestrator (NFVO) 1112, and a network manager (NM) 1114.

The VIM 1102 manages the resources of the NFVI 1104. The NFVI 1104 can include physical or virtual resources and applications (including hypervisors) used to execute the system 1100. The VIM 1102 may manage the life cycle of virtual resources with the NFVI 1104 (e.g., creation, maintenance, and tear down of virtual machines (VMs) associated with one or more physical resources), track VM instances, track performance, fault and security of VM instances and associated physical resources, and expose VM instances and associated physical resources to other management systems.

The VNFM 1106 may manage the VNFs 1108. The VNFs 1108 may be used to execute EPC components/functions. The VNFM 1106 may manage the life cycle of the VNFs 1108 and track performance, fault and security of the virtual aspects of VNFs 1108. The EM 1110 may track the performance, fault and security of the functional aspects of VNFs 1108. The tracking data from the VNFM 1106 and the EM 1110 may comprise, for example, performance measurement (PM) data used by the VIM 1102 or the NFVI 1104. Both the VNFM 1106 and the EM 1110 can scale up/down the quantity of VNFs of the system 1100.

The NFVO 1112 may coordinate, authorize, release and engage resources of the NFVI 1104 in order to provide the requested service (e.g., to execute an EPC function, component, or slice). The NM 1114 may provide a package of end-user functions with the responsibility for the management of a network, which may include network elements with VNFs, non-virtualized network functions, or both (management of the VNFs may occur via the EM 1110).

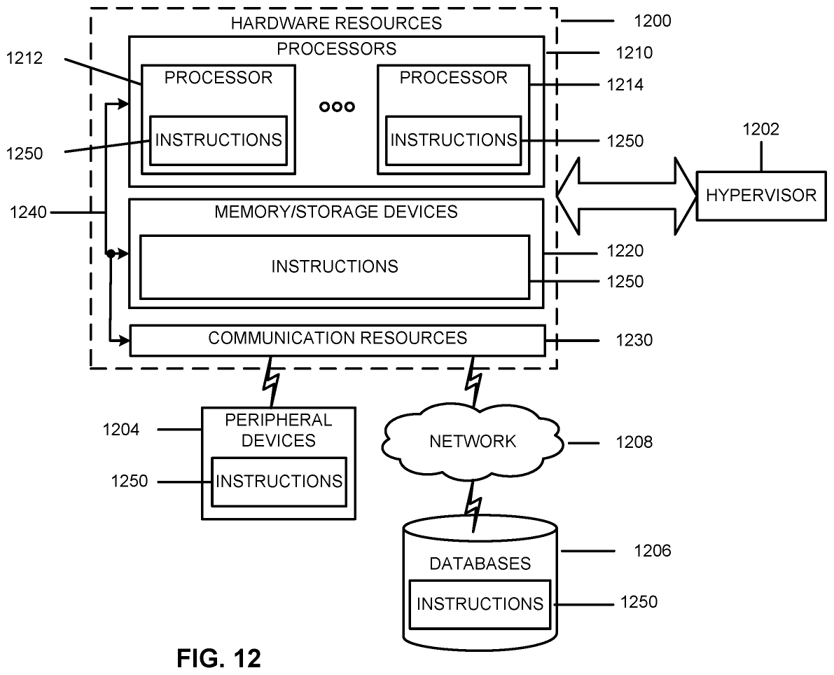

FIG. 12 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 12 shows a diagrammatic representation of hardware resources 1200 including one or more processors (or processor cores) 1210, one or more memory/storage devices 1220, and one or more communication resources 1230, each of which may be communicatively coupled via a bus 1240. For embodiments where node virtualization (e.g., NFV) is utilized, a hypervisor 1202 may be executed to provide an execution environment for one or more network slices/sub-slices to utilize the hardware resources 1200.

The processors 1210 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1212 and a processor 1214.

The memory/storage devices 1220 may include main memory, disk storage, or any suitable combination thereof. The memory/storage devices 1220 may include, but are not limited to, any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1230 may include interconnection or network interface components or other suitable devices to communicate with one or more peripheral devices 1204 or one or more databases 1206 via a network 1208. For example, the communication resources 1230 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1250 may comprise software, a program, an application, an applet, an app, or other executable code for causing at least any of the processors 1210 to perform any one or more of the methodologies discussed herein. The instructions 1250 may reside, completely or partially, within at least one of the processors 1210 (e.g., within the processor's cache memory), the memory/storage devices 1220, or any suitable combination thereof. Furthermore, any portion of the instructions 1250 may be transferred to the hardware resources 1200 from any combination of the peripheral devices 1204 or the databases 1206. Accordingly, the memory of processors 1210, the memory/storage devices 1220, the peripheral devices 1204, and the databases 1206 are examples of computer-readable and machine-readable media.

In embodiments, the devices/components of FIGS. 5, 6, 8, 9, 10, 11, 12, and particularly the baseband circuitry of FIG. 7, may be used to: configure a grantless uplink (GUL) parameter through a radio resource control (RRC) signaling; and transmit the GUL parameter to a user equipment (UE).

### Examples

Some non-limiting examples are provided below.

Example 1 includes one or more computer-readable media storing instructions, that, when executed by one or more processors, cause an evolved Node-B (eNB) to: generate a radio resource control (RRC) signal; and transmit the RRC signal to a user equipment (UE) to configure the UE with a grantless uplink (GUL) parameter.

Example 2 includes the one or more computer-readable media of example 1 or some other example herein, wherein the GUL parameter is a grantless subframe parameter to identify a validity for each of a plurality of GUL subframes.

Example 3 includes the one or more computer-readable media of example 2 or some other example herein, wherein the grantless subframe parameter is a bitmap.

Example 4 includes the one or more computer-readable media of example 1 or some other example herein, wherein the GUL parameter includes: a parameter identifying a number of configured hybrid automatic repeat request (HARQ) processes for uplink semi-persistent scheduling (ULSPS); a cell radio network temporary identifier (C-RNTI) parameter; a demodulation reference signal design (DMRS) orthogonal cover code (OCC) parameter; a DMRS cyclic shift parameter; a timer parameter; a UE-specific offset parameter; or a UE reservation signal range.

Example 5 includes the one or more computer-readable media of example 1 or some other example herein, wherein the GUL parameter includes: a nominal physical uplink shared channel (PUSCH) power parameter; a UE PUSCH power parameter; a DMRS modulation and coding scheme (MCS) parameter; a transport block (TB) number parameter; a layer number parameter; a resource allocation parameter for frequency division multiplexed (FDM) GUL; a redundant version (RV) parameter; an adjacent channel selectivity (ACS) downlink hybrid automatic repeat request (DLHARQ) flag parameter; or a downlink control information (DCI) format type parameter.

Example 6 includes the one or more computer-readable media of example 1 or some other example herein, wherein the media further stores instructions for causing the eNB to: generate a DCI message containing an amended GUL parameter that corresponds to the GUL parameter in the RRC signal; and transmit the DCI message to the UE to replace the GUL parameter with the amended GUL parameter.

Example 7 includes the one or more computer-readable media of example 6 or some other example herein, wherein the RRC signal is a first RRC signal, the GUL parameter is a first GUL parameter, and the media further stores instructions for causing the eNB to: generate a second RRC signal; and transmit the second RRC signal to the UE to configure the UE with a second GUL parameter.

Example 8 includes the one or more computer-readable media of example 1 or some other example herein, wherein to generate the RRC signal, the eNB modifies a semi-persistent scheduling (SPS) information element (IE).

Example 9 includes the one or more computer-readable media of example 1 or some other example herein, wherein the GUL parameter is configured in a cell-specific manner.

Example 10 includes the one or more computer-readable media of example 1 or some other example herein, wherein the GUL parameter is configured in a UE-specific manner.

Example 11 includes an apparatus comprising: memory to store one or more grantless uplink (GUL) parameters; and processing circuitry, coupled with the memory, to: generate a radio resource control (RRC) information element (IE) with a GUL parameter of the one or more GUL parameters; and cause the RRC IE to be transmitted to a user equipment (UE) to configure the UE for GUL transmission.

Example 12 includes the apparatus of claim 11 or some other example, wherein the GUL parameter is a grantless subframe parameter to identify a validity for each of a plurality of GUL subframes.

Example 13 includes the apparatus of claim 12 or some other example, wherein the grantless subframe parameter is a bitmap.

Example 14 includes the apparatus of claim 11 or some other example, wherein the GUL parameter includes: a parameter to identify a number of configured hybrid automatic repeat request (HARQ) processes for uplink semi-persistent scheduling (ULSPS); a cell radio network temporary identifier (C-RNTI) parameter; a demodulation reference signal (DMRS) orthogonal cover code (OCC) parameter; a DMRS cyclic shift parameter; a timer parameter; a UE-specific offset parameter; or a UE reservation signal range.

Example 15 includes the apparatus of claim 11 or some other example, wherein the GUL parameter includes: a nominal physical uplink shared channel (PUSCH) power parameter; a UE PUSCH power parameter; a DMRS modulation and coding scheme (MCS) parameter; a transport block (TB) number parameter; a layer number parameter; a resource allocation parameter for frequency division multiplexed (FDM) GUL; a redundant version (RV) parameter; an adjacent channel selectivity (ACS) downlink hybrid automatic repeat request (DLHARQ) flag parameter; or a downlink control information (DCI) format type parameter.

Example 16 includes the apparatus of claim 11 or some other example, wherein the processing circuitry is further to: generate a DCI message containing an amended GUL parameter that corresponds to the GUL parameter in the RRC IE; and transmit the DCI message to the UE to replace the GUL parameter in the RRC IE with the amended GUL parameter.

Example 17 includes an apparatus comprising: one or more processors; and one or more computer-readable media comprising instructions that, when executed by the one or more processors, cause the apparatus to: receive a radio resource control (RRC) signal containing a grantless uplink (GUL) parameter; and in response to receiving the RRC signal, configure the apparatus for GUL transmission in accordance with the GUL parameter.

Example 18 includes the apparatus of claim 17 or some other example, wherein the GUL parameter includes: a grantless subframe parameter identifying a validity for each of a plurality of GUL subframes; a parameter identifying a number of configured hybrid automatic repeat request (HARQ); processes for uplink semi-persistent scheduling (ULSPS); a cell radio network temporary identifier (C-RNTI) parameter; a demodulation reference signal design (DMRS) orthogonal cover code (OCC) parameter; a DMRS cyclic shift parameter; a timer parameter; a UE-specific offset parameter; or a UE reservation signal range.

Example 19 includes the apparatus of claim 17 or some other example, wherein the GUL parameter includes: a nominal physical uplink shared channel (PUSCH) power parameter; a UE PUSCH power parameter; a DMRS modulation and coding scheme (MCS) parameter; a transport block (TB) number parameter; a layer number parameter; a resource allocation parameter for frequency division multiplexed (FDM) GUL; a redundant version (RV) parameter; an adjacent channel selectivity (ACS) downlink hybrid automatic repeat request (DLHARQ) flag parameter; or a downlink control information (DCI) format type parameter.

Example 20 includes the apparatus of claim 17 or some other example, wherein the one or more computer-readable media further comprises instructions for causing the apparatus to: receive a DCI message containing one or more amended GUL transmission parameters, wherein each respective amended GUL transmission parameter corresponds to a respective GUL parameter in the RRC signal; and in response to receiving the DCI message, replace values in the one or more respective GUL parameters in the RRC signal with values in the one or more amended GUL transmission parameters.

Example 21 includes one or more computer-readable media storing instructions, that, when executed by one or more processors, cause an evolved Node-B (eNB) to: generate a resource control (RRC) signal comprising a grantless uplink (GUL) parameter; transmit the RRC signal to a user equipment (UE) to configure the UE with the GUL parameter; and overwrite the GUL parameter in the RRC signal with a GUL parameter configured through one or more of: a downlink control information (DCI) activation, and a DCI release.

Example 22 includes the one or more computer-readable media of example 21 or some other example, wherein the RRC comprises a plurality of GUL parameters.

Example 23 includes the one or more computer-readable media of example 22 or some other example, wherein the plurality of GUL parameters include: a grantless subframe parameter identifying a validity for each of a plurality of GUL subframes; a parameter identifying a number of configured hybrid automatic repeat request (HARQ) processes for uplink semi-persistent scheduling (ULSPS); a cell radio network temporary identifier (C-RNTI) parameter; a demodulation reference signal (DMRS) orthogonal cover code (OCC) parameter; a DMRS cyclic shift parameter; a timer parameter; a UE-specific offset parameter; or a UE reservation signal range.

Example 24 includes the one or more computer-readable media of example 22 or some other example, wherein the plurality of GUL parameters include: a nominal physical uplink shared channel (PUSCH) power parameter; a UE PUSCH power parameter; a DMRS modulation and coding scheme (MCS) parameter; a transport block (TB) number parameter; a layer number parameter; a resource allocation parameter for frequency division multiplexed (FDM) GUL; or a redundant version (RV) parameter;

Example 25 includes the one or more computer-readable media of example 21 or some other example, wherein to generate the RRC signal, the eNB modifies a semi-persistent scheduling (SPS) information element (IE).

Example 26 includes a method comprising generating a radio resource control (RRC) signal; and transmitting the RRC signal to a user equipment (UE) to configure the UE with a grantless uplink (GUL) parameter.

Example 27 includes the method of example 26 or some other example herein, wherein the GUL parameter is a grantless subframe parameter to identify a validity for each of a plurality of GUL subframes.

Example 28 includes the method of example 27 or some other example herein, wherein the grantless subframe parameter is a bitmap.

Example 29 includes the method of example 26 or some other example herein, wherein the GUL parameter includes: a parameter identifying a number of configured hybrid automatic repeat request (HARQ) processes for uplink semi-persistent scheduling (ULSPS); a cell radio network temporary identifier (C-RNTI) parameter; a demodulation reference signal design (DMRS) orthogonal cover code (OCC) parameter; a DMRS cyclic shift parameter; a timer parameter; a UE-specific offset parameter; or a UE reservation signal range.

Example 30 includes the method of example 26 or some other example herein, wherein the GUL parameter includes: a nominal physical uplink shared channel (PUSCH) power parameter; a UE PUSCH power parameter; a DMRS modulation and coding scheme (MCS) parameter; a transport block (TB) number parameter; a layer number parameter; a resource allocation parameter for frequency division multiplexed (FDM) GUL; a redundant version (RV) parameter; an adjacent channel selectivity (ACS) downlink hybrid automatic repeat request (DLHARQ) flag parameter; or a downlink control information (DCI) format type parameter.

Example 31 includes the method of example 26 or some other example herein, wherein the media further stores instructions for causing an eNB to: generate a DCI message containing an amended GUL parameter that corresponds to the GUL parameter in the RRC signal; and transmit the DCI message to the UE to replace the GUL parameter with the amended GUL parameter.

Example 32 includes the method of example 31 or some other example herein, wherein the RRC signal is a first RRC signal, the GUL parameter is a first GUL parameter, and the media further stores instructions for causing the eNB to: generate a second RRC signal; and transmit the second RRC signal to the UE to configure the UE with a second GUL parameter.

Example 33 includes the method of example 26 or some other example herein, wherein to generate the RRC signal, an eNB modifies a semi-persistent scheduling (SPS) information element (IE).

Example 34 includes the method of example 26 or some other example herein, wherein the GUL parameter is configured in a cell-specific manner.

Example 35 includes the method of example 26 or some other example herein, wherein the GUL parameter is configured in a UE-specific manner.

Example 36 includes a method comprising generating a radio resource control (RRC) information element (IE) with a GUL parameter of one or more GUL parameters; and causing the RRC IE to be transmitted to a user equipment (UE) to configure the UE for GUL transmission.

Example 37 includes the method of example 36 or some other example herein, wherein the GUL parameter is a grantless subframe parameter to identify a validity for each of a plurality of GUL subframes.

Example 38 includes the method of example 37 or some other example herein, wherein the grantless subframe parameter is a bitmap.

Example 39 includes the method of example 36 or some other example herein, wherein the GUL parameter includes: a parameter to identify a number of configured hybrid automatic repeat request (HARQ) processes for uplink semi-persistent scheduling (ULSPS); a cell radio network temporary identifier (C-RNTI) parameter; a demodulation reference signal (DMRS) orthogonal cover code (OCC) parameter; a DMRS cyclic shift parameter; a timer parameter; a UE-specific offset parameter; or a UE reservation signal range.

Example 40 includes the method of example 36 or some other example herein, wherein the GUL parameter includes: a nominal physical uplink shared channel (PUSCH) power parameter; a UE PUSCH power parameter; a DMRS modulation and coding scheme (MCS) parameter; a transport block (TB) number parameter; a layer number parameter; a resource allocation parameter for frequency division multiplexed (FDM) GUL; a redundant version (RV) parameter; an adjacent channel selectivity (ACS) downlink hybrid automatic repeat request (DLHARQ) flag parameter; or a downlink control information (DCI) format type parameter.

Example 41 includes the method of example 36 or some other example herein, wherein the processing circuitry is further to: generate a DCI message containing an amended GUL parameter that corresponds to the GUL parameter in the RRC IE; and transmit the DCI message to the UE to replace the GUL parameter in the RRC IE with the amended GUL parameter.

Example 42 includes a method comprising: receiving a radio resource control (RRC) signal containing a grantless uplink (GUL) parameter; and in response to receiving the RRC signal, configure the apparatus for GUL transmission in accordance with the GUL parameter.

Example 43 includes the method of example 42 or some other example herein, wherein the GUL parameter includes: a grantless subframe parameter identifying a validity for each of a plurality of GUL subframes; a parameter identifying a number of configured hybrid automatic repeat request (HARQ); processes for uplink semi-persistent scheduling (ULSPS); a cell radio network temporary identifier (C-RNTI) parameter; a demodulation reference signal design (DMRS) orthogonal cover code (OCC) parameter; a DMRS cyclic shift parameter; a timer parameter; a UE-specific offset parameter; or a UE reservation signal range.

Example 44 includes the method of example 42 or some other example herein, wherein the GUL parameter includes: a nominal physical uplink shared channel (PUSCH) power parameter; a UE PUSCH power parameter; a DMRS modulation and coding scheme (MCS) parameter; a transport block (TB) number parameter; a layer number parameter; a resource allocation parameter for frequency division multiplexed (FDM) GUL; a redundant version (RV) parameter; an adjacent channel selectivity (ACS) downlink hybrid automatic repeat request (DLHARQ) flag parameter; or a downlink control information (DCI) format type parameter.

Example 45 includes the method of example 42 or some other example herein, wherein the method further comprises: receiving a DCI message containing one or more amended GUL transmission parameters, wherein each respective amended GUL transmission parameter corresponds to a respective GUL parameter in the RRC signal; and in response to receiving the DCI message, replacing values in the one or more respective GUL parameters in the RRC signal with values in the one or more amended GUL transmission parameters.

Example 46 includes a method to be performed by an evolved Node-B (eNB), the method comprising: generating a resource control (RRC) signal comprising a grantless uplink (GUL) parameter; transmitting the RRC signal to a user equipment (UE) to configure the UE with the GUL parameter; and overwriting the GUL parameter in the RRC signal with a GUL parameter configured through one or more of: a downlink control information (DCI) activation, and a DCI release.

Example 47 includes the method of example 46 or some other example herein, wherein the RRC comprises a plurality of GUL parameters.

Example 48 includes the method of example 47 or some other example herein, wherein the plurality of GUL parameters include: a grantless subframe parameter identifying a validity for each of a plurality of GUL subframes; a parameter identifying a number of configured hybrid automatic repeat request (HARQ) processes for uplink semi-persistent scheduling (ULSPS); a cell radio network temporary identifier (C-RNTI) parameter; a demodulation reference signal (DMRS) orthogonal cover code (OCC) parameter; a DMRS cyclic shift parameter; a timer parameter; a UE-specific offset parameter; or a UE reservation signal range.

Example 49 includes the method of example 47 or some other example herein, wherein the plurality of GUL parameters include: a nominal physical uplink shared channel (PUSCH) power parameter; a UE PUSCH power parameter; a DMRS modulation and coding scheme (MCS) parameter; a transport block (TB) number parameter; a layer number parameter; a resource allocation parameter for frequency division multiplexed (FDM) GUL; or a redundant version (RV) parameter;

Example 50 includes the method of example 46 or some other example herein, wherein to generate the RRC signal, the eNB modifies a semi-persistent scheduling (SPS) information element (IE).

Example 51 may include an apparatus comprising means to perform one or more elements of a method described in or related to any of examples 26-50, or any other method or process described herein.

Example 52 may include one or more non-transitory computer-readable media comprising instructions to cause an electronic device, upon execution of the instructions by one or more processors of the electronic device, to perform one or more elements of a method described in or related to any of examples 26-50, or any other method or process described herein.

Example 53 may include an apparatus comprising logic, modules, and/or circuitry to perform one or more elements of a method described in or related to any of examples 26-50, or any other method or process described herein.

Example 54 may include a method, technique, or process as described in or related to any of examples 26-50, or portions or parts thereof.

Example 55 may include an apparatus comprising: one or more processors and one or more computer-readable media comprising instructions that, when executed by the one or more processors, cause the one or more processors to perform the method, techniques, or process as described in or related to any of examples 26-50, or portions thereof.

Example 56 may include a method of communicating in a wireless network as shown and described herein.

Example 57 may include a system for providing wireless communication as shown and described herein.

Example 58 may include a device for providing wireless communication as shown and described herein.

The description herein of illustrated implementations, including what is described in the Abstract, is not intended to be exhaustive or to limit the present disclosure to the precise forms disclosed. While specific implementations and examples are described herein for illustrative purposes, a variety of alternate or equivalent embodiments or implementations calculated to achieve the same purposes may be made in light of the above detailed description, without departing from the scope of the present disclosure, as those skilled in the relevant art will recognize.

1.-25. (canceled)

26. An apparatus comprising:
memory to store an indication of a grantless uplink (GUL) parameter; and
processing circuitry, coupled with the memory, to:
generate a radio resource control (RRC) signal comprising the indication of the GUL parameter; and
transmit the RRC signal to a user equipment (UE) to configure the UE based on the GUL parameter.

27. The apparatus of claim 26, wherein the GUL parameter is a grantless subframe parameter to identify a validity for each of a plurality of GUL subframes.

28. The apparatus of claim 27, wherein the grantless subframe parameter is a bitmap.

29. The apparatus of claim 26, wherein the GUL parameter includes:
a parameter identifying a number of configured hybrid automatic repeat request (HARM) processes for uplink semi-persistent scheduling (ULSPS);
a cell radio network temporary identifier (C-RNTI) parameter;
a demodulation reference signal design (DMRS) orthogonal cover code (OCC) parameter;
a DMRS cyclic shift parameter;
a timer parameter; or
a UE-specific offset parameter.

30. The apparatus of claim 26, wherein the GUL parameter includes:
a nominal physical uplink shared channel (PUSCH) power parameter;
a UE PUSCH power parameter;
a DMRS modulation and coding scheme (MCS) parameter;
a transport block (TB) number parameter;
a layer number parameter;
a resource allocation parameter for frequency division multiplexed (FDM) GUL;
a redundant version (RV) parameter;
an adjacent channel selectivity (ACS) downlink hybrid automatic repeat request (DLHARQ) flag parameter; or
a downlink control information (DCI) format type parameter.

31. The apparatus of claim 26, wherein processing circuitry is further to:
generate a DCI message containing an amended GUL parameter that corresponds to the GUL parameter in the RRC signal; and
transmit the DCI message to the UE to replace the GUL parameter with the amended GUL parameter.

32. The apparatus of claim 31, wherein the RRC signal is a first RRC signal, the GUL parameter is a first GUL parameter, and the processing circuitry is further to:
generate a second RRC signal; and
transmit the second RRC signal to the UE to configure the UE with a second GUL parameter.

33. The apparatus of claim 26, wherein to generate the RRC signal, the eNB modifies a semi-persistent scheduling (SPS) information element (IE).

34. The apparatus of claim 26, wherein the GUL parameter is configured in a cell-specific manner.

35. The apparatus of claim 26, wherein the GUL parameter is configured in a UE-specific manner.

36. One or more non-transitory, computer-readable media storing instructions that, when executed by one or more processors, cause an evolved Node-B (eNB) to:
generate a radio resource control (RRC) information element (IE) with a plurality of grantless uplink (GUL) parameters; and
encode the RRC IE for transmission to a user equipment (UE) to configure the UE for GUL transmission.

37. The one or more non-transitory, computer-readable media of claim 36, wherein the plurality of GUL parameters include a GUL parameter that is a grantless subframe parameter to identify a validity for each of a plurality of GUL subframes.

38. The one or more non-transitory, computer-readable media of claim 37, wherein the grantless subframe parameter is a bitmap.

39. The one or more non-transitory, computer-readable media of claim 36, wherein the plurality of GUL parameters include:
a parameter to identify a number of configured hybrid automatic repeat request (HARM) processes for uplink semi-persistent scheduling (ULSPS);
a cell radio network temporary identifier (C-RNTI) parameter;
a demodulation reference signal (DMRS) orthogonal cover code (OCC) parameter;
a DMRS cyclic shift parameter;
a timer parameter; or
a UE-specific offset parameter.

40. The one or more non-transitory, computer-readable media of claim 36, wherein the plurality of GUL parameters include:
a nominal physical uplink shared channel (PUSCH) power parameter;
a UE PUSCH power parameter;
a DMRS modulation and coding scheme (MCS) parameter;
a transport block (TB) number parameter;
a layer number parameter;
a resource allocation parameter for frequency division multiplexed (FDM) GUL;
a redundant version (RV) parameter;
an adjacent channel selectivity (ACS) downlink hybrid automatic repeat request (DLHARQ) flag parameter; or
a downlink control information (DCI) format type parameter.

41. The one or more non-transitory, computer-readable media of claim 36, wherein the one or more computer-readable media further comprises instructions for causing the eNB to:
generate a DCI message containing an amended GUL parameter that corresponds to a first GUL parameter from the plurality of GUL parameters in the RRC IE; and
transmit the DCI message to the UE to replace the first GUL parameter in the RRC IE with the amended GUL parameter.

42. One or more non-transitory, computer-readable media storing instructions that, when executed by one or more processors, cause a user equipment (UE) to:
receive a radio resource control (RRC) signal containing a grantless uplink (GUL) parameter; and
in response to receiving the RRC signal, configure the apparatus for GUL transmission in accordance with the GUL parameter.

43. The one or more non-transitory, computer-readable media of claim 42, wherein the GUL parameter includes:
a grantless subframe parameter identifying a validity for each of a plurality of GUL subframes;
a parameter identifying a number of configured hybrid automatic repeat request (HARQ); processes for uplink semi-persistent scheduling (ULSPS);
a cell radio network temporary identifier (C-RNTI) parameter;
a demodulation reference signal design (DMRS) orthogonal cover code (OCC) parameter;
a DMRS cyclic shift parameter;
a timer parameter; or
a UE-specific offset parameter.

44. The one or more non-transitory, computer-readable media of claim 42, wherein the GUL parameter includes:
a nominal physical uplink shared channel (PUSCH) power parameter;
a UE PUSCH power parameter;
a DMRS modulation and coding scheme (MCS) parameter;
a transport block (TB) number parameter;
a layer number parameter;
a resource allocation parameter for frequency division multiplexed (FDM) GUL;
a redundant version (RV) parameter;
an adjacent channel selectivity (ACS) downlink hybrid automatic repeat request (DLHARQ) flag parameter; or
a downlink control information (DCI) format type parameter.

45. The one or more non-transitory, computer-readable media of claim 42, wherein the one or more computer-readable media further comprises instructions for causing the UE to:
receive a DCI message containing one or more amended GUL transmission parameters, wherein each respective amended GUL transmission parameter corresponds to a respective GUL parameter in the RRC signal; and
in response to receiving the DCI message, replace values in the one or more respective GUL parameters in the RRC signal with values in the one or more amended GUL transmission parameters.
